(19) United States
(12) Patent Application Publication
(10) Pub. No.: US 2021/0165971 A1
(43) Pub. Date: Jun. 3, 2021

(54) APPARATUS AND METHOD FOR AUTOMATIC TRANSLATION

(71) Applicant: Electronics and Telecommunications Research Institute, Daejeon (KR)

(72) Inventors: Yo Han LEE, Siheung-si (KR); Young Kil KIM, Daejeon (KR)

(73) Assignee: Electronics and Telecommunications Research Institute, Daejeon (KR)

(21) Appl. No.: 17/104,317

(22) Filed: Nov. 25, 2020

(30) Foreign Application Priority Data
Nov. 29, 2019 (KR) 10-2019-0156749

(51) Int. Cl. G06F 40/47; G06F 40/284; G06F 40/30

(52) U.S. Cl. CPC G06F 40/47; G06F 40/30; G06F 40/284

(57) ABSTRACT

Provided are an apparatus and method for automatic translation, and more specifically, an apparatus and method for automatic translation between low-resource languages lacking learning data. The apparatus includes an inputter configured to receive a source language, which is a low-resource language, and a third language abundant in resources compared to the low-resource language, a memory configured to store a program for performing automatic translation between the source language, which is the low-resource language, and a target language using the third language, and a processor configured to execute the program, wherein the processor performs the automatic translation using a third language vocabulary embedding vector.

### CROSS-REFERENCE TO RELATED APPLICATION

This application claims priority to and the benefit of Korean Patent Applications No. 10-2019-0156749, filed on Nov. 29, 2019, the disclosures of which are incorporated herein by reference in its entirety.

### BACKGROUND

### 1. Field of the Invention

The present invention relates to an apparatus and method for automatic translation, and more specifically, to an apparatus and method for automatic translation between low-resource languages lacking learning data.

### 2. Discussion of Related Art

Recently, automatic translation services have been provided based on a neural machine translation model that outputs natural translation results compared to rule-based and statistics-based translation models.

For a language pair lacking learning data (a parallel corpus), a technique that uses language resources having a relatively large amount of learning data for translation between low-resource languages lacking learning data has been proposed, but languages that do not share a vocabulary surface form have high complexity in learning and low translation performance.

### SUMMARY OF THE INVENTION

The present invention provides an apparatus and method for automatic translation that are capable of improving translation performance between low-resource languages lacking learning data using a third language having a large amount of learning data.

The technical objectives of the present invention are not limited to the above, and other objectives may become apparent to those of ordinary skill in the art on the basis of the following description.

According to an aspect of the present invention, there is provided an apparatus for automatic translation, the apparatus including: an inputter configured to receive a source language, which is a low-resource language, and a third language abundant in resources compared to the low-resource language; a memory configured to store a program which performs automatic translation between the source language, which is the low-resource language, and a target language using the third language; and a processor configured to execute the program, wherein the processor performs the automatic translation using a third language vocabulary embedding vector.

According to an aspect of the present invention, there is provided a method of automatic translation, the method including the steps of: (a) receiving a token sequence of a source language and a token sequence of a third language; (b) expressing each token of the token sequences into an embedding vector; and (c) generating a target language token sequence using the embedding vector and outputting the generated target language token sequence.

According to an aspect of the present invention, there is provided an apparatus for automatic translation including: a source language encoder configured to model a sentence from a source language embedding vector that is an expression of each token of a token sequence of a source language through an embedding layer; a third language encoder configured to model a sentence from a third language embedding vector that is an expression of each token of a token sequence of a third language through an embedding layer; a target language decoder configured to generate a target language token sequence corresponding to sentence information received from the source language encoder or the third language encoder; and a third language decoder configured to generate a third language token sequence according to sentence information received from the source language encoder.

### BRIEF DESCRIPTION OF THE DRAWINGS

FIGS. 1 to 3 illustrate an apparatus for automatic translation according to an embodiment of the present invention.

FIG. 4 illustrates a vocabulary embedding mapping module according to an embodiment of the present invention.

FIG. 5 illustrates a method of automatic translation according to an embodiment of the present invention.

FIG. 6 is a view illustrating an example of a computer system in which a method according to an embodiment of the present invention is performed.

### DETAILED DESCRIPTION OF EXEMPLARY EMBODIMENTS

Hereinafter, the above and other objectives, advantages, and features of the present invention and manners of achieving them will become readily apparent with reference to descriptions of the following detailed embodiments when considered in conjunction with the accompanying drawings.

However, the scope of the present invention is not limited to such embodiments, and the present invention may be embodied in various forms. The embodiments to be described below are provided only to assist those skilled in the art in fully understanding the objectives, constitutions, and the effects of the invention, and the scope of the present invention is defined only by the appended claims.

Meanwhile, terms used herein are used to aid in the explanation and understanding of the present invention and are not intended to limit the scope and spirit of the present invention. It should be understood that the singular forms “a,” “an,” and “the” also include the plural forms unless the context clearly dictates otherwise. The terms “comprises,” “comprising,” “includes,” and/or “including,” when used herein, specify the presence of stated features, integers, steps, operations, elements, components and/or groups thereof and do not preclude the presence or addition of one or more other features, integers, steps, operations, elements, components, and/or groups thereof.

Before describing embodiments of the present invention, a background for proposing the present invention will be described first for the sake of understanding of those skilled in the art.

Recently, automatic translation services have been provided based on a neural machine translation model that outputs natural translation results compared to a rule-based and statistics-based translation model.

The neural machine translation model requires a large amount of parallel corpuses including sentence pairs including a source language sentence, which is an object of translation, and a target language sentence, which is a result of translation, and in the case of a language pair lacking learning data (a parallel corpus), the translation performance is significantly lowered.

Constructing the parallel corpus is very time-consuming and expensive, and the conventional technology utilizes language resources having a large amount of learning data for translation between low-resource languages lacking learning data.

A representative one of the methods is a zero-shot learning method that learns a parallel corpus between multiple languages for a single translation model.

According to the zero-shot learning method, for example, to train a Vietnamese-Korean translation model, not only a Vietnamese-Korean parallel corpus, but also an English-Vietnamese parallel corpus and an English-Korean parallel corpus, which are relatively abundant, are used to train the Vietnamese-Korean translation model.

Even with the same meaning, the vocabulary surface form may be different between a third language and a low-resource language, and thus the conventional zero-shot learning implicitly learns the meaning by treating an embedding vector of each vocabulary to be different.

The zero-shot learning method shows high performance in some languages that have the same vocabulary surface form, such as in [French, English]-Vietnamese, but in some languages that do not share the vocabulary surface form, requires implicit learning of surface forms due to having different surface forms even with the same meaning, which causes high complexity of learning and low translation performance.

The present invention is proposed in view of the above-described limitations and proposes an apparatus and method for utilizing language resources with a relatively large amount of learning data for automatic translation between low-resource languages with a small amount of learning data.

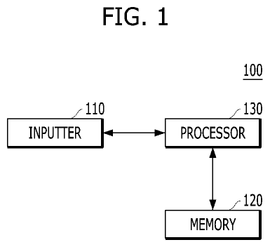

FIGS. 1 to 3 illustrate an apparatus for automatic translation according to an embodiment of the present invention, in which a translation model supports multilingual translation between a low-resource language and a third language.

Referring to FIG. 1, the apparatus for automatic translation apparatus according to the embodiment of the present invention includes an inputter 110 configured to receive a source language, which is a low-resource language, and a third language abundant in resources compared to the low-resource language, a memory 120 configured to store a program for performing automatic translation between the source language, which is the low-resource language, and a target language using the third language, and a processor 130 configured to execute the program, wherein the processor 130 performs the automatic translation using a third vocabulary embedding vector.

The processor 130 expresses each token of a source language token sequence and a third language token sequence input into the inputter 110 into an embedding vector through an embedding layer and models a meaning and a structure of a sentence.

The processor 130 calculates a weight vector by measuring a distance between an input embedding vector and a third language vocabulary embedding vector and generates a third language weight embedding vector using the weight vector and an embedding matrix of third language vocabulary words.

The processor 130 generates a final embedding vector using the input embedding vector and the third language weight embedding vector.

The processor 130 allows parameters of a lower layer of a source language encoder to be tied to parameters of a lower layer of a third language encoder and allows parameters of a lower layer of a target language decoder to be tied to parameters of a lower layer of a third language decoder.

A parallel corpus between the third language and the low-resource language is larger than that of a parallel corpus between the low-resource languages, and the third language may include one or more languages.

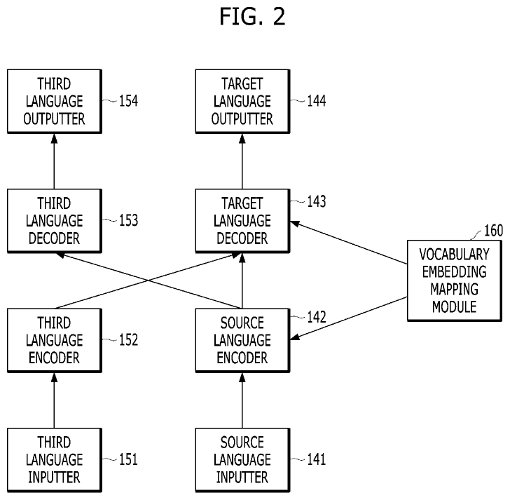

Referring to FIG. 2, translation between a source language and a target language, which form a low-resource language pair, is modeled by a source language encoder 142 and a target language decoder 143.

Translation between the third language, which is relatively abundant in learning resources, and the target language is modeled by a third language encoder 152 and the target language decoder 143.

Translation between the source language and the third language is modeled by the source language encoder 142 and a third language decoder 153.

A parallel corpus, which is a language pair-specific learning resource, may be simultaneously learned for the translation model shown in FIGS. 1 and 2.

The encoder and the decoder model the meaning and structure of a sentence from an embedding vector that represents the meaning of a vocabulary word for each language.

Since the vocabulary embedding vector of the source language and the target language, which form a low-resource language pair, may be highly likely to be inaccurate, the translation model according to the embodiment of the present invention uses a third language vocabulary embedding vector, which has a relatively accurate semantic representation, through a vocabulary embedding mapping module 160.

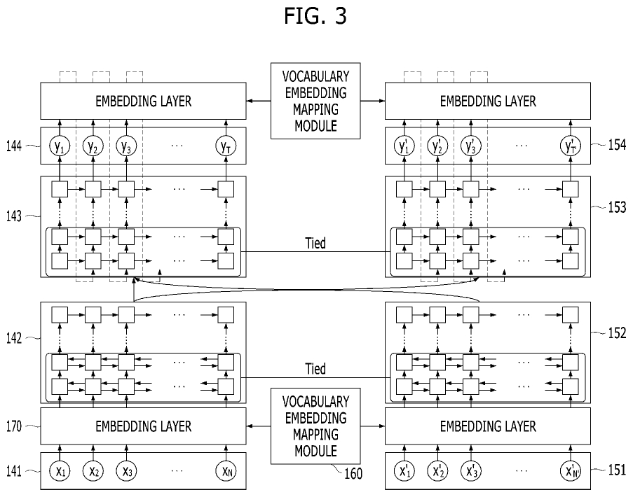

Referring to FIG. 3, sentences of each language are separated in units of tokens and modeled by an encoder or a decoder.

Each token in a source language token sequence input to a source language inputter 141 is expressed as an embedding vector representing a meaning through an embedding layer 170.

The source language encoder 142 models the meaning and structure of the entire sentence from the source language embedding vector.

Each token in a third language token sequence input to a third language inputter 151 is expressed as an embedding vector representing a meaning through an embedding layer 170.

The third language encoder 152 models the meaning and structure of the entire sentence from the third language embedding vector.

The target language decoder 143 receives sentence information from the source language encoder 142 or the third language encoder 152, generates a target language token sequence corresponding to the received sentence information, and outputs the target language token sequence through a target language outputter 144.

The third language decoder 153 receives sentence information from the source language encoder 142, generates a token sequence corresponding to the received sentence information, and outputs the token sequence through a third language outputter 154.

According to the embodiment of the present invention, the following method is constructed for vocabulary and sentence semantic representation so that a third language resource having a different vocabulary surface form may be efficiently used for translation between low-resource languages.

According to the embodiment of the present invention, since the semantic representation of the source language and the target language vocabulary (i.e., low-resource languages) is not properly modeled, the vocabulary embedding vector of the source/target language is complemented using the source language, the target language, and the vocabulary embedding mapping module 160.

According to the embodiment of the present invention, the source language encoder 142 and the target language decoder 143 that model the meaning and structure of a sentence of a low-resource language use the third language encoder 152 and the third language decoder 153 for more accurate semantic representation

Lower layers of an encoder and a decoder tend to model sentence meanings, while higher layers of an encoder and a decoder tend to model sentence structures that are abstract.

Accordingly, parameters the lower layer of the source language encoder 142 are tied to parameters of the lower layer of the third language encoder 152, and parameters of the lower layer of the target language decoder 143 are tied to parameters of the lower layer of the third language decoder 153, thereby complementing the sentence semantic representation of the source language encoder 142 and the target language decoder 143 that model the low-resource language sentences.

For the division of the upper layer and the lower layer, a division boundary may be set according to a result of monitoring the trend of performance change, and at least one lower layer is set.

Since the low-resource language and the third language may have different sentence structure forms, parameters are not tied between upper layers.

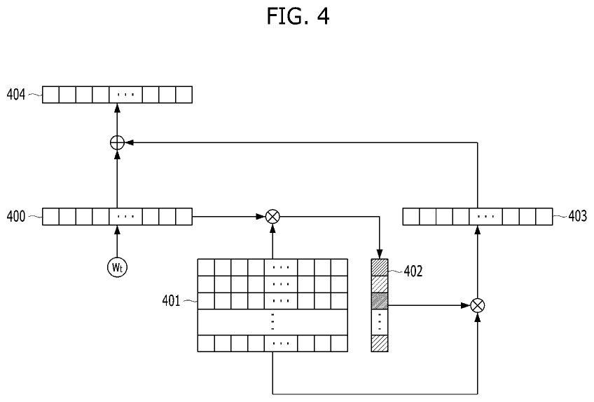

FIG. 4 illustrates a process of generating a final embedding vector by the vocabulary embedding mapping module 160 according to the embodiment of the present invention.

Referring to FIG. 4, wₜ denotes a source language vocabulary or target language vocabulary, and each token has one embedding vector 400.

The vocabulary embedding mapping module 160 measures the distance between the input embedding vector 400 and an embedding matrix 401 of third language vocabularies to calculate a weight vector 402 indicating the degree of association between the input vocabulary and the third language vocabularies.

The embedding mapping module 160 multiplies the embedding matrix 401 of third language vocabularies by the weight vector 402 to generate a third language weight embedding vector 403.

The embedding mapping module 160 generates the embedding vector from the weight for the degree of association between the input vocabulary and the third language vocabulary so that an embedding vector of a third language vocabulary associated with an input vocabulary is reflected.

$$weight ( {w}_{t} , {w}_{i}^{′} ) = \frac{exp ( similarity ( {w}_{t} , {w}_{i}^{′} ) )}{{\sum }_{i = 1}^{\vert V \vert} exp [ similarity ( {w}_{t} , {w}_{i}^{′} ) ]} \qquad [ Equation 1 ]$$

The weight vector is expressed as a softmax distribution for the similarity between an input vocabulary wₜ and a third language vocabulary w′ as is shown in Equation 1 (wherein |V| is the number of third language vocabularies).

The degree of similarity between vocabularies may be calculated through a differentiable function, such as a Euclidean distance and a cosine distance of the vocabulary embedding vector.

The third language weight embedding vector 403 is calculated as a product of the weight vector 402 and the embedding matrix 401 of the third language vocabularies.

relative embedding(wₜ)=Σᵢ₌₁^{|V|}weight(wₜ, wⁱ′)*emb(wᵢ′) Equation 2

The vocabulary embedding mapping module 160 generates a final embedding vector 404 by summating the embedding vector 400 of the input vocabulary and the third language weight embedding vector 403.

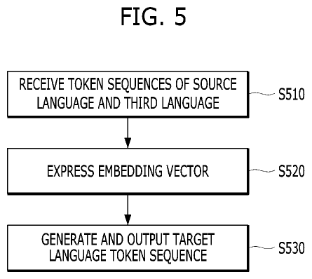

FIG. 5 illustrates a method of automatic translation according to an embodiment of the present invention.

The method of automatic translation according to the embodiment of the present invention includes receiving token sequences of a source language and a third language (S510), expressing each token of the token sequences into an embedding vector (S520), and generating a target token sequence using the embedding vector and outputting the generated target token sequence (S530).

In operation S510, the token sequences of the source language, which is a low-resource language, and the third language, which has a larger amount of resources than the low-resource language, are received.

In operation S520, parameters of lower layers of encoder and decoder networks for modeling the source language, which is a low-resource language, are allowed to be tied to parameters of lower layers of encoder and decoder networks for modeling the third language.

In operation S520, a weight vector for the similarity between an input vocabulary and a third language vocabulary is calculated, a third language weight embedding vector is generated using the weight vector and an embedding matrix of the third language, and a final embedding vector is generated using the embedding vector of the input vocabulary and third language weight embedding vector.

Meanwhile, the method of automatic translation according to the embodiment of the present invention may be implemented in a computer system or may be recorded on a recording medium. The computer system may include at least one processor, a memory, a user input device, a data communication bus, a user output device, and a storage. The above described components perform data communication through the data communication bus.

The computer system may further include a network interface coupled to a network. The processor may be a central processing unit (CPU) or a semiconductor device for processing instructions stored in the memory and/or storage.

The memory and the storage may include various forms of volatile or nonvolatile media. For example, the memory may include a read only memory (ROM) or a random-access memory (RAM).

Accordingly, the method of automatic translation according to the embodiment of the present invention may be implemented in the form executable by a computer. When the method of automatic translation according to the embodiment of the present invention is performed by the computer, instructions readable by the computer may perform the method of automatic translation according to the present invention.

Meanwhile, the method of automatic translation according to the present invention may be embodied as computer readable codes on a computer-readable recording medium. The computer-readable recording medium is any recording medium that can store data that can be read thereafter by a computer system. Examples of the computer-readable recording medium include a ROM, a RAM, a magnetic tape, a magnetic disk, a flash memory, an optical data storage, and the like. In addition, the computer-readable recording medium may be distributed over network-connected computer systems so that computer readable codes may be stored and executed in a distributed manner.

As is apparent from the above, the apparatus and method for automatic translation construct a translation model between low-resource languages using translation knowledge between a third language relatively abundant in resources and a low-resource language, generate an embedding vector having a more accurate semantic representation using a vocabulary relationship between the low-resource language and the third language, and allow parameters of encoder and decoder networks of the third language to be tied to parameters of encoder and decoder networks of the low-resource language so that a sentence semantic representation of encoder and decoder networks of the low-resource language can be complemented.

The effects of the present invention are not limited to those mentioned above, and other effects not mentioned above will be clearly understood by those skilled in the art from the above detailed description.

Although the present invention has been described with reference to the embodiments, a person of ordinary skill in the art should appreciate that various modifications, equivalents, and other embodiments are possible without departing from the scope and sprit of the present invention. Therefore, the embodiments disclosed above should be construed as being illustrative rather than limiting the present invention. The scope of the present invention is not defined by the above embodiments but by the appended claims of the present invention, and the present invention is to cover all modifications, equivalents, and alternatives falling within the spirit and scope of the present invention.

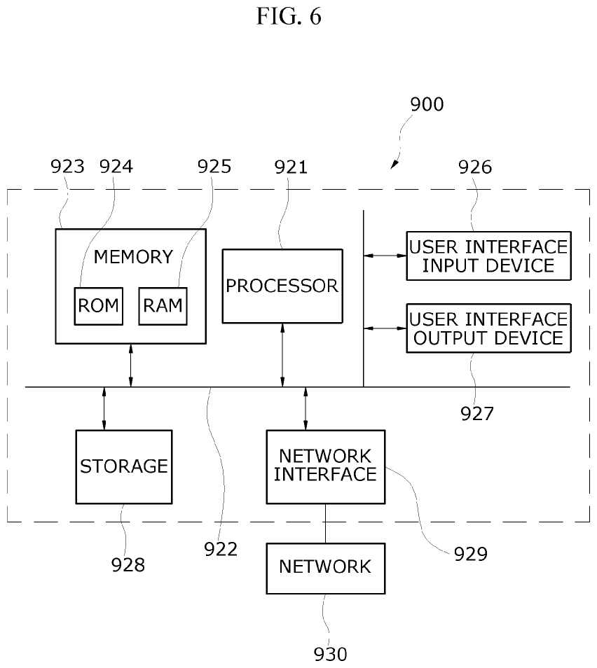

The method according to an embodiment of the present invention may be implemented in a computer system or may be recorded in a recording medium. FIG. 6 illustrates a simple embodiment of a computer system. As illustrated, the computer system may include one or more processors 921, a memory 923, a user input device 926, a data communication bus 922, a user output device 927, a storage 928, and the like. These components perform data communication through the data communication bus 922.

Also, the computer system may further include a network interface 929 coupled to a network. The processor 921 may be a central processing unit (CPU) or a semiconductor device that processes a command stored in the memory 923 and/or the storage 928.

The memory 923 and the storage 928 may include various types of volatile or non-volatile storage mediums. For example, the memory 923 may include a ROM 924 and a RAM 925.

Thus, the method according to an embodiment of the present invention may be implemented as a method that can be executable in the computer system. When the method according to an embodiment of the present invention is performed in the computer system, computer-readable commands may perform the producing method according to the present invention.

The method according to the present invention may also be embodied as computer-readable codes on a computer-readable recording medium. The computer-readable recording medium is any data storage device that may store data which may be thereafter read by a computer system. Examples of the computer-readable recording medium include read-only memory (ROM), random access memory (RAM), CD-ROMs, magnetic tapes, floppy disks, and optical data storage devices. The computer-readable recording medium may also be distributed over network coupled computer systems so that the computer-readable code may be stored and executed in a distributed fashion.

The technical objectives of the present invention are not limited to the above, and other objectives may become apparent to those of ordinary skill in the art based on the specification.

Although the present invention has been described with reference to the embodiments, a person of ordinary skill in the art should appreciate that various modifications, equivalents, and other embodiments are possible without departing from the scope and sprit of the present invention. Therefore, the embodiments disclosed above should be construed as being illustrative rather than limiting the present invention. The scope of the present invention is not defined by the above embodiments but by the appended claims of the present invention, and the present invention is to cover all modifications, equivalents, and alternatives falling within the spirit and scope of the present invention.

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

What is claimed is:

1. An apparatus for automatic translation, comprising:
an inputter configured to receive a source language, which is a low-resource language, and a third language abundant in resources compared to the low-resource language;
a memory configured to store a program which performs automatic translation between the source language, which is the low-resource language, and a target language using the third language; and
a processor configured to execute the program,
wherein the processor performs the automatic translation using a third language vocabulary embedding vector.

2. The apparatus of claim 1, wherein the processor expresses each token of a source language token sequence and a third language token sequence input to the inputter into an embedding vector through an embedding layer and models a meaning and a structure of a sentence.

3. The apparatus of claim 2, wherein the processor calculates a weight vector by measuring a distance between an input embedding vector and the third language vocabulary embedding vector and generates a third language weight embedding vector using the weight vector and an embedding matrix of third language vocabularies.

4. The apparatus of claim 3, wherein the processor generates a final embedding vector using the input embedding vector and the third language weight embedding vector.

5. The apparatus of claim 1, wherein the processor allows parameters of a lower layer of a source language encoder to be tied to parameters of a lower layer of a third language encoder, and parameters of a lower layer of a target language decoder to be tied to parameters of a lower layer of a third language decoder.

6. A method of automatic translation, comprising the steps of:
(a) receiving a token sequence of a source language and a token sequence of a third language;
(b) expressing each token of the token sequences into an embedding vector; and
(c) generating a target language token sequence using the embedding vector and outputting the generated target language token sequence.

7. The method of claim 6, wherein the step (a) includes receiving the token sequence of the source language, which is a low-resource language, and the token sequence of the third language abundant in resources compared to the low-resource language.

8. The method of claim 7, wherein the step (b) includes allowing parameters of lower layers of encoder and decoder networks for modeling the source language to be tied to parameters of lower layers of encoder and decoder networks for modeling the third language.

9. The method of claim 6, wherein the step (b) includes:
calculating a weight vector for a similarity between an input vocabulary and a third language vocabulary;
generating a third language weight embedding vector using the weight vector and an embedding matrix of the third language; and
generating a final embedding vector using an embedding vector of the input vocabulary and the third language weight embedding vector.

10. An apparatus for automatic translation, comprising:
a source language encoder configured to model a sentence from a source language embedding vector that is an expression of each token of a token sequence of a source language through an embedding layer;
a third language encoder configured to model a sentence from a third language embedding vector that is an expression of each token of a token sequence of a third language through an embedding layer;
a target language decoder configured to generate a target language token sequence corresponding to sentence information received from the source language encoder or the third language encoder; and
a third language decoder configured to generate a third language token sequence according to sentence information received from the source language encoder.

11. The apparatus of claim 10, further comprising a vocabulary embedding mapping module configured to:
generate a weight vector for a similarity between an input vocabulary of the source language and a vocabulary word of the third language;
generate a third language weight embedding vector using the weight vector and an embedding matrix of the third language vocabularies; and
generate a final embedding vector using an embedding vector of the input vocabulary and the third language weight embedding vector.

12. The apparatus of claim 10, wherein parameters of a lower layer of the source language encoder are tied to parameters of a lower layer of the third language encoder, and parameters of a lower layer of the target language decoder are tied to parameters of a lower layer of the third language decoder.

13. The apparatus of claim 12, wherein the lower layer is distinguished by a boundary set according to a result of monitoring a trend of an automatic translation performance change.
